(19) United States
(12) Patent Application Publication
(10) Pub. No.: US 2018/0096253 A1
(43) Pub. Date: Apr. 5, 2018

(54) RARE EVENT FORECASTING SYSTEM AND METHOD

(71) Applicant: Civicscape, LLC, Chicago, IL (US)

(72) Inventors: Brett Jonathan Goldstein, Washington Island, WI (US); Maggie Kate King, South Bend, IN (US)

(21) Appl. No.: 15/284,734

(22) Filed: Oct. 4, 2016

(51) Int. Cl. G06N 7/00; G06N 99/00

(52) U.S. Cl. CPC G06N 7/005; G06N 99/005

(57) ABSTRACT

A system and method for predicting or forecasting rare events, such as instances of violent crime within a spatial region, in combination with other correlative variables, such as weather data. One or more machine learning algorithms is employed in order to predict rare events in conjunction with geospatial information and one or more correlative variables. By employing a combination of a downsampling of the rare event data, followed by the application of an ensemble of machine learning algorithms, increased precision of the predictions of future occurrences of the rare events may be achieved.

### BACKGROUND OF THE INVENTION

### 1. Field of the Invention

The present invention relates, in general, to event forecasting and, more particularly, to a system and method of predicting the occurrence of rare events, such as, for example, instances of violent crime within specific spatial and temporal parameters.

### 2. General Background of the Invention

Predictive policing, including the use of mathematical and analytical techniques to predict criminal activity, among other things, is becoming an increasingly popular tool in law enforcement. Currently, police departments in major cities tend to rely heavily on historical crime trends by time and location to anticipate future outbreaks in crime. The CompStat system established in 1994 in New York City used weekly data on crime complaints, arrests, and summons activity to identify patterns in crime activity and inform decisions about where to allocate police resources. By the year 2014, approximately 85% of the 500 police departments from the largest cities in the U.S. responding to a survey on the topic reported adopting similar programs to CompStat.

The popularity of crime mapping and geographical information systems, combined with the availability of historical point-level crime data in some jurisdictions being made available to researchers, has led to increased research regarding variation in crime trends spatially within a city, including research around the patterns of crime at fine-grained units of spatial analysis. This, in turn, has lead to findings that the occurrence of crime is closely related to place, that a majority of crimes occur in only a subset of street segments within a city, and that crimes tend to cluster in areas of a city that are larger than one block but smaller than the traditional community area or other large neighborhood-level unit.

Variables that correlate with the occurrence of crime events, such as, for example, weather data, have also been studied by researchers. The research exploring the relationship between weather and criminal activity has, to date, been largely causal in nature, with a lesser emphasis on predictions. Two prominent theories regarding correlation between weather and crime are the social contact theory, focused on human interactions, and the aggressive human behavior theory, focused on individual behaviors. The social contact theory posits that favorable weather conditions encourage social interaction, ultimately bringing offenders and victims together and increasing crime rates. Inclement weather, such as cold ambient temperature, reduces the number of persons available as victims, as people tend to stay off the street during bad weather. However, those few individuals who are outdoors during unpleasant weather are more vulnerable as there are fewer potential witnesses to deter the criminal. The aggressive human behavior theory is based in physiology and suggests that external conditions directly affect human judgment, heightening aggression and reducing capacity for self-control. This theory posits, with some experimental support, that high ambient temperatures lead to increased aggression levels.

Among the types of crimes that have been studied in connection with possible correlation with ambient temperature are violent crimes, including homicide, manslaughter, simple and aggravated assault, intimidation, and sex crimes. Certain forms of criminal activity, such as, for example, instances of violent crime, tend to occur relatively infrequently, even in major metropolitan areas. Rarely occurring events, such as violent crime, have proven to be difficult to forecast.

Accordingly, it is an object of the present invention to provide a system and method for forecasting the future occurrence of rare events, such as, for example, violent crimes within spatial regions or subsets of a city, with increased precision.

It is another object of the present invention to provide a system and method for forecasting rare events, such as, for example, violent crimes, in conjunction with forecasted correlative variables, such as, for example, weather data.

These and other objects and features of the present invention will become apparent in view of the present specification, drawings and claims.

### SUMMARY OF THE INVENTION

The present invention presents a system and method for predicting or forecasting rare events, such as instances of violent crime within a spatial region, in combination with other correlative variables, such as weather data. In particular, one or more machine learning algorithms is employed in order to predict rare events in conjunction with geospatial information and one or more correlative variables.

Existing machine learning algorithms, standing alone, are not particularly well suited to working with rare event data, i.e., data that tends to be highly unbalanced between the number of “events” in the dataset versus “non events”. Existing data on rare events, such as historical crime events, is combined with variables that correlate with a rare data event, such as a crime event, such as, for example, weather data, emergency incident call data, non-emergency incident call data, social media-derived data, or other predictive variables, to calculate risk assessments for future events of a similar nature. Conventional predictive algorithms tend not to perform well on rare-event, or unbalanced data. Specifically, conventional machine learning algorithms tend to misclassify all events as non-events, as they are not sophisticated enough to accommodate the unbalanced nature of the rare event data employed in training the model.

The inventors have discovered that, by employing a combination of a downsampling of the rare event data, followed by the application of an ensemble of machine learning algorithms, significantly more precise predictions may be made concerning the future occurrences of rare events, such as violent crime.

The present invention comprises a database storing rare event data, such as historical violent crime incident data, and historical data on at least one correlative variable, such as, in the case of violent crime, historical weather data, including ambient temperature data. One or more software modules of an overall analysis unit process the stored data, using a portion of the data to build one or more crime risk forecast models. The processed data and models are then used, in conjunction with forecast data for the correlative variable(s), to create forecasts for future rare events, such as violent crimes, within defined future temporal and spatial units. The data processing is preferably automatically rerun using some or all of these processes on a repeated (i.e. hourly, weekly or some other recurring interval) basis on newly available data.

In an exemplary embodiment of the present invention, software modules calculate the risk for both where and when crime is likely to happen in the next 72 hours, with hourly forecasts for each of Chicago's 866 census tracts. The forecasts rely not only upon the historical locational and temporal trends of the underlying crime data, but also forward-looking data on weather.

The software modules of the analysis unit join disparate historical data (i.e. historical weather data and historical crime data) by a defined temporal interval (i.e. hourly) and defined spatial interval (i.e., a city block, a census tract, etc.), generating one joint data set of historical data for each user-defined community (i.e., a city, neighborhood, etc.). Each data set is preprocessed for model training by downsampling—i.e., creating a random subsets of the full data set that comprise only a random subset of non-event rows in the full data set, formatting the columns in the smaller data sets into a user- or modeler-defined feature list, training each subset data sample with a machine learning algorithm, saving the trained models for each subsetted data set (i.e., 100 subsets of data may be employed to create 100 trained models), running a new sample of formatted data through each of the trained models, aggregating predicted results for each of the trained models by spatial and temporal unit and by date, automatically repeating some or all of the foregoing processes on a user or modeler-defined recurring basis and generating further predictions within a selected geospatial region (i.e. a city or neighborhood) and for a specific time period (i.e. for the next 72 hours) based upon predefined data limits (i.e., the last 5 years of data), and automatically sending predicted results on a recurring basis to a user interface.

The forecasted data may be accessed via a graphical user interface, which may be provided via web browsers and/or desktop and responsive design applications. The user interface preferably includes, in the case of violent crime data, a layer mapping the crime risk predicted for each spatial unit and crime type forecasted, for a particular temporal unit. One interactive layer is preferably provided in conjunction with the mapping functionality, enabling a user to toggle between different temporal units, in order to easily view and perceive a change in the forecast by spatial unit through future times forecasted. Another interactive layer is preferably provided in conjunction with the mapping functionality to enable a user to toggle between different crime and call types, to easily view and perceive a change in the risk forecast by crime or call type.

The user interface may further enable a user to select a particular spatial unit and view additional graphical and textual information, explaining the risk for crime within the specific spatial unit over a span of time, which may include past, historical data as well as future, predictive data. The user interface may further enable a user to select a particular spatial unit and view additional graphical and textual information, explaining the estimated correlation between variables such as weather on the risk forecasts for each spatial and temporal unit.

### BRIEF DESCRIPTION OF THE DRAWINGS

FIG. 1 of the drawings is a block diagram showing the processors and other hardware employed in implementing an embodiment of the present invention;

FIG. 2 of the drawings is a block diagram showing the training pipeline portion of a computer-implemented method according to the present invention;

FIG. 3 of the drawings is a block diagram showing, in further detail, the downsampling portion of the training pipeline of FIG. 2; and

FIG. 4 of the drawings is a block diagram showing the forecasting pipeline portion of a computer-implemented method according to the present invention.

### DETAILED DESCRIPTION OF THE INVENTION

While the present invention is susceptible of embodiment in many different forms, one exemplary embodiment, in which downsampling of historical violent crime data for the city of Chicago, Ill. USA is applied to an ensemble of machine learning algorithms in the form of 100 feed-forward artificial neural networks, will be described in detail.

Reported incidents of homicide and aggravated battery reported in Chicago over a period of approximately 7.5 years is used as the target predictions for the models to be generated. A collection of variables on weather conditions, temporal conditions such as time of day and day of week, and spatial factors, (i.e. the location of each crime within the city) are used as predictors.

The weather and crime data are grouped together by census tract and date, and by hour of the day. These spatial and temporal units of analysis are used as factors in the predictive models. As such, the models are built on a data set that consists of a discrete variable for the count of occurrences of a crime within a data subset by census tract and hour, for every day in the approximately 7.5 year sample, together with a weather reading for each correlative weather variable under consideration, also by hour and tract.

Each crime report contains information including the specific date and time the crime was reported, as well as the latitude and longitude at which each crime was reported to have occurred.

Weather variables included in the exemplary model are temperature, precipitation, relative humidity, and wind speed, sourced from U.S. government records. The data includes weather conditions on an hourly basis at six different locations in the city of Chicago. Hourly reports from each of the stations are averaged by hour, and one average reading is assigned to each tract and hour in the data set. In addition to the values for each hour and census tract, time lagged values are further included to capture the potential impact of weather changes.

To account for changes in temperature, the model includes changes for the previous 24, 48, and 72 hours, and for the previous 1 and 2 weeks. For rainfall, the model data includes the number of hours in the last 24 and 72 hours that some amount of rain was recorded, the number of hours in the last week that some amount of rain was recorded, and the number of hours since some amount of rain was recorded.

The model includes a selection of important spatial and temporal controls as additional features in order to improve the precision of the predictions. The temporal features included are hour and day of the week (accounting for differences between weekdays and weekends), and other seasonal indicators inclusive of month, and year, with a binary indicator variable for each. To account for spatial variation in the predictions, the model includes include a binary indicator for each census tract in the data set. The exemplary model also considers the spatial correlation between census tracts.

The model combines the violent crimes and the weather values described above into hourly reports for every census tract for the entire city, effectively creating an hourly observation for every census tract in the data set of the 7.5 years of historical data. There are 866 census tracts in Chicago, each typically comprising 3-5 block groups and up to 10,000 residents, with an average of 2000-4,000 residents per census tract.

The exemplary model recodes the disparate weather and crime datasets into a single longitudinal set that uses the census tract as the geospatial unit of analysis and hour of day by date as the temporal unit of analysis. The recoding joins the weather values (as outlined above) with day of week (accounting for differences between weekdays and weekends), and the other seasonal indicators (inclusive of month, year), with a discrete variable for each row for the count of violent crimes (i.e. homicides and aggravated batteries) that took place in that observation.

Sufficiently small temporal and geospatial unit sizes are preferably employed, for two reasons. First, the model constructs spatial and temporal units of analysis into small, plausibly homogeneous units in order to relax the assumption that the impact of weather on crime is the same across a city and through time. A larger temporal unit, i.e. a 24 hour period of time, includes substantial variation in crime within the period.

The exemplary model employs one hour periods and models effects within each hour, with an expectation for reasonable homogeneity within these hourly units when controlling for spatial variation as well. The use of hourly units accommodates the hypothesis that the relationship between, for example, temperature and crime may be stronger during late night hours than morning hours, as well as the fact that temperature can vary within a 24 hour period.

Census tracts are employed as the spatial unit of analysis in the exemplary model because they are relatively small spatial units that were initially designed to be roughly homogeneous with respect to population characteristics, economic status, and living conditions. Creating subsets of crime data by hour and into just a subset of crimes that are rare relative to a set of all crime events generates a data set of events that is relatively sparse in nature. Moreover, predictions in small units of time and space are considered to be more operationally useful in the field. A model that predicts that a violent crime may occur with high probability within a census tract-sized geometry, which is comprised of multiple blocks, and hour time span can be translated into steps to take on the part of public safety organizations, as compared to a model that predicts with high probability, and the same level of accuracy, that a violent crime may happen within a particular block of the city, at some unknown time over the period of a day. A prediction that does not provide sufficient spatial and temporal information to develop a targeted response has diminished operational utility.

To predict violent crime, the exemplary model applies downsampling to the previously described data preparation step to better account for the rare event nature of violent crimes in the predictive model. A training set is created from the initial population of all crimes and no-crime occurrences, by decreasing the sampling rate of non-crime occurrences to crime occurrences at a certain ratio.

As indicated above, violent crimes are relatively rare events. In the training data set for the exemplary model, the proportion of events to non-events may be approximately 0.001. The ratio of hours by day that a violent crime is recorded to have occurred within each census tract (1+) to the ratio of hours by day within each tract that a violent crime was not recorded to have occurred (0) is extremely low. This phenomenon is commonly referred to as imbalanced data or rare event data.

Machine learning algorithms can be biased towards the majority class when the training set is imbalanced data, sharply underestimating the probability of rare events. As a result, rare events have traditionally proved challenging to predict.

Downsampling, a form of choice-based sampling, involves sampling from the original data to create a more balanced training set. Specifically, downsampling mimics a case-cohort design of choice-based sampling in which all of the events and only a random selection of all of the non-events are combined into the sample used to train a model using a machine learning algorithm. Ultimately, downsampling increases the prevalence of events compared to zeroes, or non-events, in the dataset. This is useful because events can be shown to be more statistically informative than zeroes in cases with rare events data, where there is vastly less information in each additional zero in the data, relative to each additional event.

To downsample, the exemplary model under-samples the majority class (non-crime events) by randomly removing majority class cases from the majority class population until the majority class falls to equal a pre-specified ratio to the minority class (crime events) in the sample. In the exemplary model, the optimal ratio of downsampling is determined by evaluating a confusion matrix of the results in the validation dataset on a set of ratios: 100:1, 50:1, 10:1, 5:1, 3:1, 2:1, and 1:1. For each ratio, the exemplary model builds 10 downsampled data sets per ratio. 10 models are trained using a machine learning algorithm, one for each downsampled set, for each of the ratios in the set described.

Downsampling is a form of selection on the dependent variable, which can introduce bias into the model results. To address this, an ensemble of machine learning models are employed, each based on a separate, independently drawn random sample of non-events combined with the same sample of all positive events in the training set. To generate each training sample, random draws with replacement from the full training data set of non-events are employed. In the exemplary model, 100 downsampled datasets are employed, with each trained on a separate feed forward neural network. While alternative machine learning algorithms, and ensembles of such alternative algorithms, are also contemplated by the present invention, feed forward neural networks are preferred for their ability to detect the nonlinearity in data and capture the important interactions between different variables. Each neural network preferably includes an additional layer of hidden nodes, enabling the networks to select the most result-relevant variables from a large variety of the input variables, as well as capture the combined effect of these variables that leads to the final result.

The input nodes of each neural network of the ensemble represent a set of binary variables to control for the hour, day of week, month, and possible year effects in the data, as well as an indicator for census tract and variables to measure the effect of weather, including all of the weather variables described previously. The output node of each neural network of the ensemble is a node that represents the outcome of the current case. As a result, the predicted results of each neural network in the ensemble are an estimate, unconstrained but falling between 0 and 1 by nature of the distribution of the count input data, representing the level of risk of a crime in the downsampled data set.

In addition, an ensemble learning approach is taken. This approach is considered to promote the model variance and further improve predictive precision. Different randomized initializations are chosen for different neural networks of the ensemble, and each neural network is trained on a different sub-dataset. The results that are produced by all the models are aggregated together by averaging to produce a final result.

The uncertainty surrounding each prediction is estimated by tract and hour, in two ways. First, the variance and standard deviation for each prediction is calculated by tract and hour for every day across all 100 neural network models averaged for that tract-hour-date. Second, the uncertainty in the predictions is tracked over time as the model generates new risk assessments with new data. Every hour after the initial predictive model is completed by the initial training of the 100 neural networks, the system uses the latest weather forecasts to generate a new set of predictions for every census tract over the next 72 hours. As a result of changing weather forecasts, the system's prediction for a given hour may change during the 72 hours leading up to that hour. By running the tool repeatedly with new weather data reported each hour, and saving out the predictions for all previous hours/tracts in the database, the system is able to track the uncertainty in its predictions by tract and hour over time.

Due to the size of the initial training data, a mid-range computing resource, such as a cluster of several hundred computing nodes, is preferably employed to train the 100 feed forward neural networks in parallel. During the training, the 100 downsampled subsets of the training data are randomly created. For each of the training data subsets, a separate neural network with ten hidden nodes and one output node is created. Each model includes a set of binary variables to control for the hour, day of week, month, and possible year effects in the data, as well as an indicator for census tract and variables to measure the effect of weather, including all of the weather variables described previously.

In this example, the R programming language and the open source neural network R package known as nnet is suitable for use in the exemplary embodiment of the present invention. The parameters of the neural network model are estimated in this algorithm using back propagation. Before the training, the parameters of the neural network are initialized as random values that are uniformly distributed between −0.1 to 0.1. In order to regularize the cost function to avoid overfitting, the weight decay is set as 5e-4. The back propagation is then applied iteratively to update the model parameters. At each iteration, a mini-batch of the data is presented as the input to the network, and the network processes the input data and produces the prediction errors by comparing the resulting outputs with the expected results. These errors are back-propagated through the network, and the loss function gradient is calculated iteratively for the parameters in each layer of the network. In order to minimize the prediction errors, the parameters of the network are then calculated according to the magnitude and the direction of the gradient. This process occurs multiple times as the entire training dataset is processed repeatedly in order to allow the weights to be continually updated.

The training process is stopped when the neural network starts to converge. In the exemplary model training process, training continues for a sufficient number of epochs, or complete passes through the entire dataset, defining sufficient as the point when the optimization reaches the local minima of the loss function. After the training, each trained neural net is stored as one of the base models, as it is trained using the historical data. In one example, approximately 80% of the historical data is used for training, with the remaining 20% being withheld and used to test the trained model, and the training process is stopped after 200 epochs as the optimization reaches the local minima at that value.

The above methodology imposes the assumption of stationarity in the data. That assumption, while desirable, is not likely to hold into the future. Rather, the number of crimes by tract and hour is anticipated to change in a statistically meaningful manner over time after the initial model has been trained. As such, the system should preferably offer some way that the estimated effects of the result-relevant features will also change accordingly to maintain accuracy. For this reason, the system is provided with the capability of adjusting its parameter settings in the initial model based on new incoming data. An updated model can be trained using the updated data by the same method described above, except that initialization of the parameters of the updated models uses the parameters of the corresponding base models that were initially trained. The weights trained in the neural network are updated with the new data. In the exemplary embodiment, the base models can be updated as often as the updated data on weather and recent historical crime events is obtained. In the present system, the base model may, for example, be updated on a regular interval, as updated crime information and weather data becomes available. This does not remove the assumption of stationarity, but instead creates a framework within which the assumption continues to be reasonably plausible.

The present invention may further comprise a presentation layer including a graphical user interface, such as, for example, a web browser, desktop application, or responsive design application that communicates the predictive information in a way that is both understandable and updated frequently enough to be relevant for public safety operations. The data is preferably presented in a manner allowing both comparisons of predicted crime levels over time across a city, as well as more detailed information at the census tract level. This presentation, spread over time and area makes, the overall tool relevant for decision-makers at many different levels.

The graphical user interface preferably provides at least 72 hours of forward-looking census-level crime predictions as risk assessments for a municipality. The neural-network models described earlier are communicated through the user interface in a manner that provides easily understood information on the risk of criminal activity on the census tract level. These predictions are preferably updated on an hourly basis using the most recent forecasted weather data as it is made available.

An overall system of the present invention may be set up as a pipeline that converts weather and crime data to predictions on an hourly basis by way of the trained models outlined above, and as a front-end website or other graphical user interface which displays and interprets the results of these predictive models. The website may show, for example, the risk of violent crime in all of the census tracts in Chicago by hour and updates the results on an hourly basis.

The prediction pipeline has five major steps: pulling crime and weather data from a back end database, joining the data to census tract files, formatting the columns in the data set to match that of the training data columns, running the data through the models described above and outputting the predictions to a web interface. The pipeline is automatically executed on an hourly basis.

The models in the pipeline are the models that are discussed above and are initially static models trained on the base historical data. The models can be updated on a recurring interval to adjust for recent trends and to incorporate new data. This flexibility allows the system's predictions to remain accurate as the underlying data changes. Each category of crime is given its own model and risk assessments.

The regular gathering of new data and creation of new predictions allows for accurate, timely and actionable risk assessments for practitioners. Additionally, the system for training the master models for each crime follows the same general method in each city, making the underlying source code easily replicable. The pipeline is able to adjust to new models and inputs as more relevant data that can improve the model becomes available.

The graphical user interface is preferably a responsive design website that displays all of the risk assessments by census tract by hour. These predictions are displayed on the city level with more information on each census tract, and with a map that supports pan and zoom for views of the entire city or of smaller areas. This setup allows the tool to have multiple test cases that support the requirements of different stakeholders. High-level decision makers are able to allocate resources citywide while local patrols are able to understand how their location conditions will change in the near term.

A citywide view provides a visual overview of how likely a given tract is to have a crime in a given hour relative to the city average for that hour, using a heat map with a divergent color palette. Providing relative crime risk allows practitioners to identify the areas of the city that are most likely to have a crime and to thus direct resources to that area. Additionally, it normalizes crime predictions.

In order to facilitate operational use, the graphical user interface provides a slider bar that allows end users to view the entire city map for any hour within the next 72 hours. This allows for users to create resource plans in advance and adjust them as needed when predictions change.

The graphical user interface also allows the user to select any census tract and see a more detailed view that includes a 72-hour timeline for the selected tract. The individual tract pages include timelines for the risk assessments of each of the different types of crime predicted for that census tract. The individual tract views also include weather predictions, allowing users to see the relationship that upcoming weather events may have with an individual precinct or patrol area and allow them to adjust their expectations and methods accordingly.

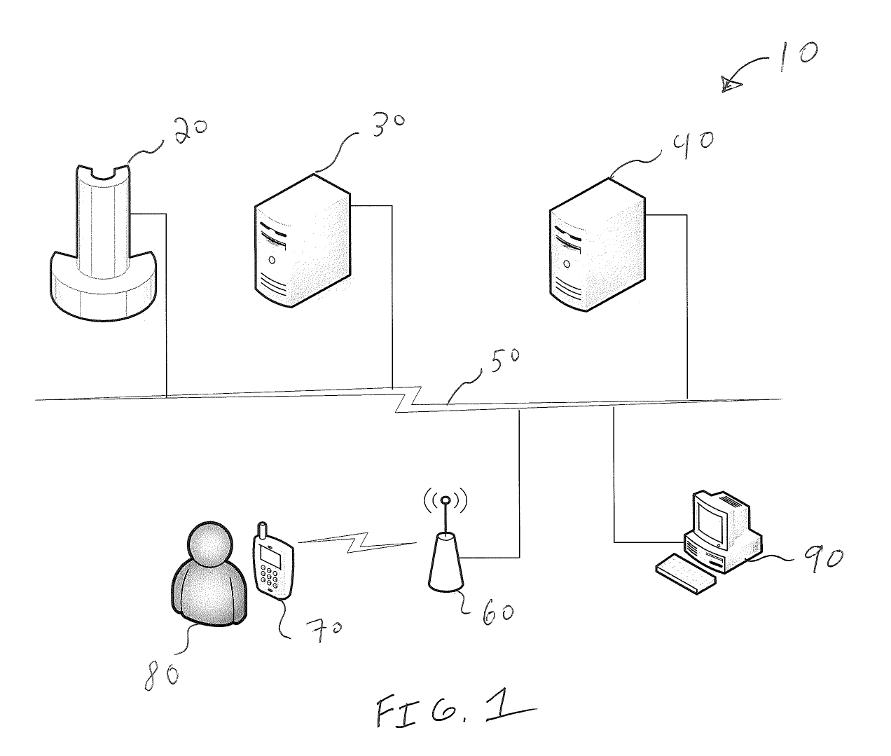

Processors and other hardware 10 that may be employed in implementing a system according to the present invention are shown in FIG. 1 as comprising a computer 20, database server 30, hardware server 40, network 50, wireless access point 60, portable computing device 70, and desktop computer 90. Alternatively, computer 20 and hardware server may comprise a single computing resource. Similarly, database server may alternatively comprise the same computing resource as computer 20 and/or hardware server 40. Network 50, which may include one or more of local area networks, wide area networks, and global networks such as the internet, provides a data link interconnecting the various processors and devices of the system. Computer 20, which may comprise a computing resource such as a cluster of several hundred parallel computing nodes, includes a machine learning training module of the analysis unit, programmed to execute instructions to perform the training of the machine learning algorithm such as, for example, an ensemble of feed forward neural networks.

Database server 30, which alternatively may be a shared resource with hardware server 40, rather than a separate physical server, may be employed to store data including, in the exemplary embodiment, rare event data in the form of historical violent crime data, correlative variable predictor data in the form of hourly weather data, a reshaped, aggregate database of rare event and correlative variable data, downsampled data according to the present invention, and predicted result data output by the ensemble machine learning algorithm.

Hardware processor 40, which alternatively may be a shared resource with computer 20, is programmed with processing modules of the analysis unit to perform instructions to, in turn, perform various portions of the method and system of the present invention. A data pre-processing module of the analysis unit receives historical rare event data and correlative variable data, and merges and reshapes the data into a single combined database. A downsampling module of the analysis unit downsamples the merged/reshaped data into a form more suitable for addressing rare event data by the predictive machine learning algorithm. A real-time data processing module of the analysis unit receives weather or other correlative variable data on a regular, periodic basis, and reshapes the data for use by the system. A forecasting module of the analysis unit applies the previously trained feed forward network ensemble or other suitable machine learning algorithm to the real-time predictive data in order to generate a current set of predicted results.

The forecasted results generated by the forecasting module of the analysis unit running on hardware processor 40 is preferably presented to the user via one or more graphic user interfaces. A first presentation module, in the form of a desktop application or a web browser, performs instructions enabling a user to interactively view and explore the predictive data on any computing device 90. A second presentation module, in the form of a responsive design, performs instructions enabling a responsive design user 80 to likewise interactively view and explore the predictive data on responsive design computing device 70, which may comprise a smartphone, tablet, or similar computing device.

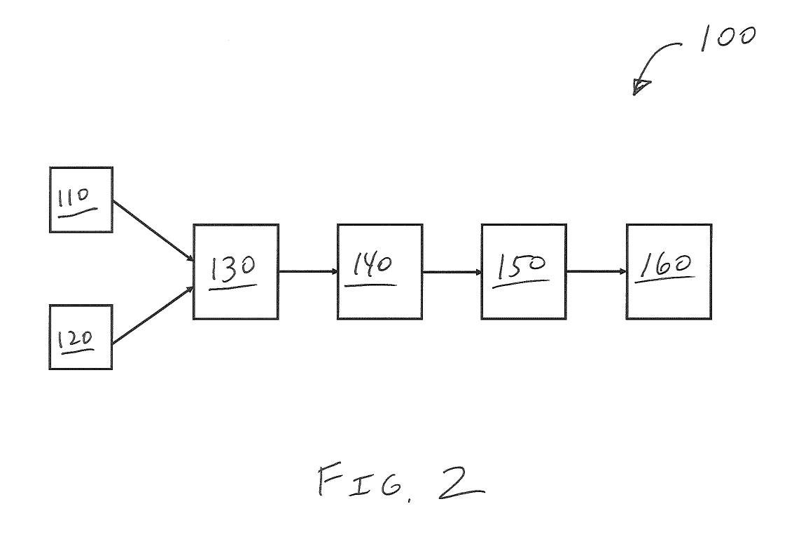

A block diagram of the training pipeline 100 of an embodiment of the present invention is shown in FIG. 2. In step 110, a processor, such as hardware processor 40, performs instructions to receive historical violent crime or other rare event data and stores it in a region of a database, which may reside on the same hardware processor, or a separate server, such as database server 30. The historical data may be derived from a publicly available source, such as, for example, an open data portal published and maintained by the City of Chicago. In the exemplary embodiment, this data is extracted with a 7-day lag from the City of Chicago Open Data Portal, which receives its data from the Chicago Police Department's CLEAR (Citizen Law Enforcement Analysis and Reporting) system. Each crime report contains information including the exact time the crime was reported and the latitude and longitude at which each crime was reported to have occurred. The subset of rare event violent crime data that is processed by the exemplary model of the present invention is defined in a manner considered consistent with the FBI's National Incident-Based Reporting System (NIBRS) Uniform Crime Reporting (UCR) classifications for violent crimes, with certain modifications. NIBRS classifies the following types of crime as violent crimes: Homicide 1st and 2nd Degree (FBI code 01A), Criminal Sexual Assault (FBI code 02), Robbery (FBI code 03), Aggravated Assault (FBI code 04A), and Aggravated Battery (FBI code 04B). The target variable in the target violent crime data to be processed by the present invention is defined as all cases of 1st and 2nd Degree Homicide (FBI code 01A) as well as the following specific types of Aggravated Battery: Aggravated Battery involving a Handgun (IUCR code 041A), Aggravated Battery involving Other Firearm (IUCR code 041B), Aggravated Battery involving Knife/Cutting Instrument (IUCR code 0420), Aggravated involving Other Dangerous Weapon (IUCR code 0430), Aggravated Battery involving Hands/First/Feet with Serious Injury (IUCR code 0479), and Aggravated Battery involving a Senior Citizen (IUCR code 0495).

In step 120, hardware processor 40 performs instructions to receive historical correlative variable data, such as historical weather data, and stores it in another region of database server 30. Weather variables included in the model are temperature, precipitation, relative humidity, and wind speed, all sourced from the National Oceanic and Atmospheric Administration (NOAA). NOAA reports of weather conditions on an hourly basis are obtained for six different locations in the city of Chicago. Reports from each of the stations is averaged by the hour, with one average reading assigned to each census tract and hour in the data set. In addition to the values for each hour and census tract, lagged values are included in order to capture the potential impact of weather changes over time.

To account for changes in temperature, the data set also includes changes for the previous 24, 48, and 72 hours, and for the previous 1 and 2 weeks. For precipitation, the data set includes precipitation in the prior 24 and 72 in which some amount of rainfall was recorded, the number of hours in the prior week that some amount of rainfall was recorded, and the number of hours since some amount of rain was recorded.

In step 130, hardware processor 40 performs instructions to reshape and process the rare event and predictive data received in steps 110 and 120, and stores the resultant data within a joint database of database server 30. In the exemplary model, the violent crime and the weather values described above are combined into hourly reports for every census tract for the City of Chicago, effectively creating an hourly observation for every census tract in the data set, preferably over a span of many years. The processing of step 130 includes recoding the disparate weather and crime datasets into a single longitudinal set that uses the census tract as the geospatial unit of analysis and hour of day by date as the temporal unit of analysis. The recoding joins the weather values (as outlined above) with day of week (accounting for differences between weekdays and weekends), and other seasonal indicators (inclusive of month, year), with a discrete variable for each row for the count of violent crimes (i.e. homicides and aggravated batteries as described above) that took place in that observation.

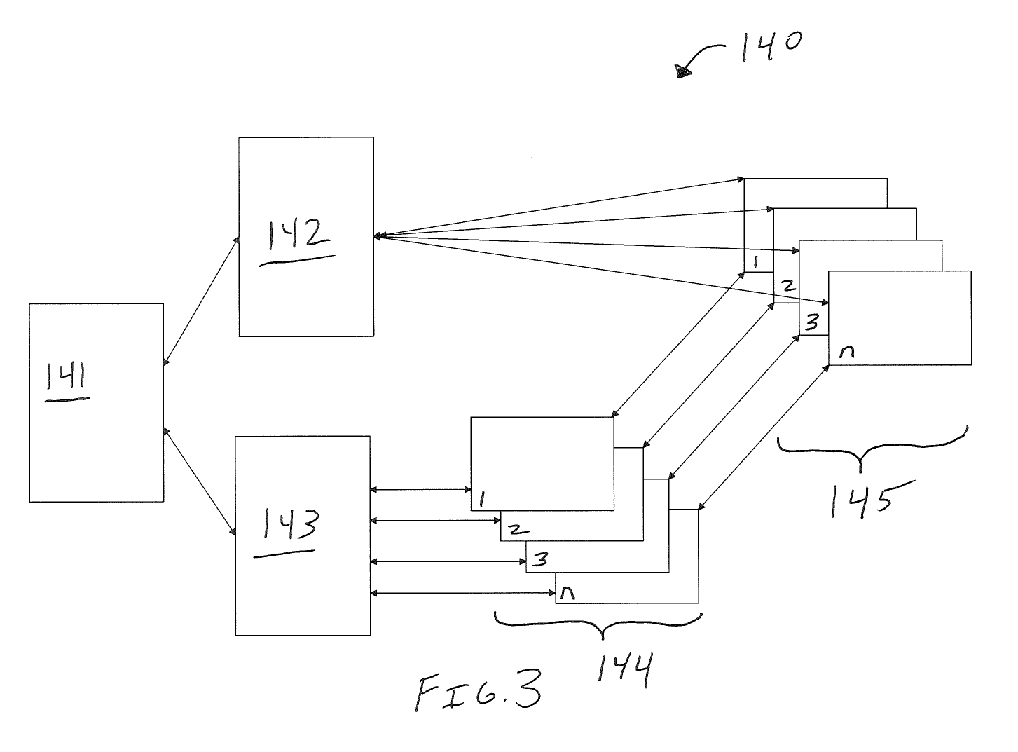

In step 140, hardware processor 40 performs instructions to downsample the historical crime data to place the data into a format more suitable for the processing of its rare event nature by the neural networks or other ensemble machine learning algorithms. As shown in further detail in FIG. 3, in the downsampling process, incident-level crime data 141 is reshaped into a dataset that includes a count of crime or binary indicator for crime in every spatial and temporal unit in the data.

To downsample, the majority class (i.e., non-crime events) are under-sampled by randomly removing majority class cases from the majority class population until the majority class falls to equal a pre-specified ratio to the minority class (i.e., crime events) in the sample. The optimal ratio of downsampling can be determined by evaluating a confusion matrix of the results in the validation dataset on a set of ratios, for example: 100:1, 50:1, 10:1, 5:1, 3:1, 2:1, and 1:1. For each ratio, ten downsampled data sets are built. Ten machine learning models are then trained, one for each downsampled set, for each of the ratios in the set. Test data is then run through the resulting models, with the results being averaged across census tract, hour, and date, with comparisons made of the results for each set of models for each ratio to the true observed data in the test set.

As downsampling is a form of selection on the dependant variable, which can introduce bias into the model results, an ensemble of machine learning models is built, each based on a separate, independently drawn random sample of non-events combined with the same sample of all positive events in the training set. To generate each training sample, data is randomly drawn with replacement from the full training data set of non events.

As shown in FIG. 3, the downsampling step 140 comprises first splitting the reshaped data set 141 into two subsets: the set 142 of positive events in the data set, namely all of the incidents of crime in the data (all of the rows with >=1 in the crime count); and the set 143 of negative events in the data set, namely all of the non-incidents in the data (all of the rows=0 in the crime count). In step 144, the set of non-incidents 143 is “down-sampled” n times. In the exemplary embodiment, n is equal to 100. The downsampling algorithm specifically entails randomly drawing from the non-incident data×number of non-incident cases, where x is equal to a pre-specified ratio of the number of non-incidents of crime to the number of crime events recorded in the full sample. The pre-specified ratio can vary by city or region. The result of the downsampling algorithm is the joining 145 of all positive events separately to each of the n samples of negative events, creating namely, n separate subsets of the fully reshaped data set, each with a different, random set of non-incidents and the same, consistent set of all crime incidents, at a ratio of non-incidents to incidents in each n sample equal to x. For example, for a ratio of 2:1 (x=2) for 100 samples (n=100), there are 100 subsetted datasets, each with twice as many non-incident rows as incident rows in each set. The number of incident rows is equal to the number of crimes recorded in the full sample of all crimes and non-crime events created prior to downsampling.

Referring back to FIG. 2, following the completion of downsampling step 140 in the overall training pipeline, the resulting 100 downsampled datasets 145 are made available to computing resource 20, where a machine learning algorithm training step 150 is performed. Specifically, a training module of the analysis unit within computer 20 is programmed to execute instructions to train an ensemble of machine learning algorithms, such as, in the exemplary embodiment, an ensemble of 100 feed forward neural networks, with each neural network being trained on an associated one of the 100 downsampled datasets 145. Each neural network includes some number of hidden nodes, for example in the model cited there can be ten hidden nodes, and one output node. The input nodes of each neural network of the ensemble represent a set of binary variables to control for the hour, day of week, month, and possible year effects in the data, as well as an indicator for census tract and variables to measure the effect of weather, including all of the weather variables described previously. The output node of each neural network of the ensemble is a node that represents the outcome of the current case. As a result, the predicted results of each neural network in the ensemble are an estimate, unconstrained but falling between 0 and 1 by nature of the distribution of the count input data, representing the level of risk of a crime in the downsampled data set. The trained machine learning models are then stored to be made available for use by the forecasting pipeline.

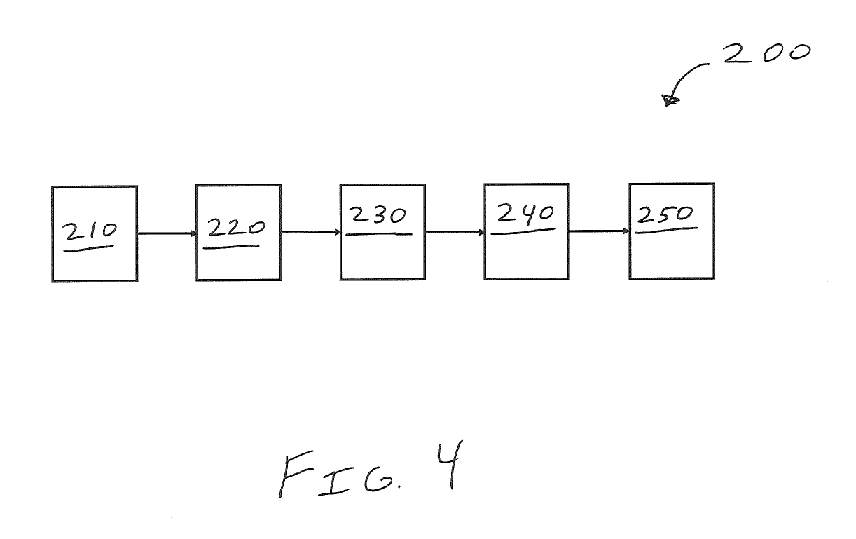

A block diagram of the forecasting pipeline 200 of an embodiment of the present invention is shown in FIG. 4. In step 210, a data input and reshaping module of the analysis unit within processor 40 executes instructions causing predictor variable data, such as weather forecast data in the exemplary embodiment, to be received from an outside source, such as, for example, on an hourly basis, and stored within database server 30. In step 220, the data input and reshaping module of the analysis unit executes instructions to reshape the input data to generate variable values from the predictor data into a form suitable for submission to the input nodes of the previously trained feed forward neural networks. In step 230, a machine learning algorithm module of the analysis unit of processor 40 executes instructions causing each of the 100 previously trained neural networks to operate on the predictor variable data. In step 240, the machine learning algorithm module of the analysis unit of processor 40 executes further instructions to average the predicted results output from each of the 100 trained models, producing average results by date, hour, and spatial unit (i.e., census tract). In step 240, an output module of the analysis unit of processor 40 executes instructions to format and export the combined predicted results where, in step 250, they are saved on database server 30. As described above, graphical user interface applications on desktop, laptop and responsive design devices may then be employed to enable users to access and view the predicted results in a meaningful manner.

It will be understood that modifications and variations may be effected without departing from the spirit and scope of the present invention. It will be appreciated that the present disclosure is intended as an exemplification of the invention and is not intended to limit the invention to the specific embodiments illustrated and described. The disclosure is intended to cover, by the appended claims, all such modifications as fall within the scope of the claims.

What is claimed is:

1. A computer implemented method for forecasting a likelihood of future occurrence of a rare event within predetermined spatial and temporal units, the method comprising the steps of:
storing first historical data of past occurrences of events of the same category as that of the rare event;
storing second historical data of at least one predictor variable previously found to correlate to occurrences of the rare event;
joining the first historical data and the second historical data into an aggregate database;
downsampling the aggregate database to remove at least some imbalances from the aggregate database;
applying a machine learning algorithm to the downsampled aggregate database in a training phase of the machine learning algorithm;
obtaining predictor value data of the at least one predictor value; and
applying the machine learning algorithm to the predictor value data to obtain forecasts of the likelihood of future occurrence of the rare event within the predetermined spatial and temporal units.

2. The method according to claim 1, wherein the rare event comprises occurrences of at least one of crime, calls, and incidents.

3. The method according to claim 1, wherein the machine learning algorithm comprises an ensemble of machine learning algorithms.

4. The method according to claim 1, wherein the machine learning algorithm comprises an ensemble of neural networks.

5. The method according to claim 1, wherein the predictor variable is selected from the group comprising temperature, precipitation, relative humidity, and wind speed.

6. The method according to claim 1, wherein the spatial unit is a census tract.

7. The method according to claim 1, wherein the temporal unit is an hour.

8. The method according to claim 1, wherein the step of downsampling comprises the steps of:
dividing the aggregate database into a positive event dataset and a negative event dataset;
creating a quantity n samples of the negative event dataset each by randomly removing, with replacement for each new n sample, entries from the negative event dataset; and
joining all of the positive events to each of the n samples of the negative event dataset.

9. A rare event forecasting system for forecasting a likelihood of future occurrence of a rare event within predetermined spatial and temporal units, comprising:
a database storing first historical data of past occurrences of events of the same category as that of the rare event and storing second historical data of at least one predictor variable previously found to correlate to occurrences of the rare event; and
an analysis unit that:
joins the first historical data and the second historical data into an aggregate database;
downsamples the aggregate database to remove at least some imbalances from the aggregate database;
applies a machine learning algorithm to the downsampled aggregate database in a training phase of the machine learning algorithm;
obtains predictor value data of the at least one predictor value; and
applies the machine learning algorithm to the predictor value data to obtain forecasts of the likelihood of future occurrence of the rare event within the predetermined spatial and temporal units.

10. The system according to claim 9, wherein the rare event comprises occurrences of at least one of crime, calls and incidents.

11. The system according to claim 9, wherein the machine learning algorithm comprises an ensemble of machine learning algorithms.

12. The system according to claim 9, wherein the machine learning algorithm comprises an ensemble of neural networks.

13. The system according to claim 9, wherein the predictor variable is selected from the group comprising forecasted temperature, precipitation, relative humidity, and wind speed.

14. The system according to claim 9, wherein the spatial unit is a census tract.

15. The system according to claim 9, wherein the temporal unit is an hour.

16. The system according to claim 9, wherein, in downsampling the aggregate database to remove at least some imbalances from the aggregate database, the analysis unit:
divides the aggregate database into a positive event dataset and a negative event dataset;
creates a quantity n samples of the negative event dataset each by randomly removing, with replacement for each new n sample, entries from the negative event dataset; and
joins all of the positive events to each of the n samples of the negative event dataset.
